(19) United States
(12) Patent Application Publication
(10) Pub. No.: US 2020/0286102 A1
(43) Pub. Date: Sep. 10, 2020

(54) PROCESS FOR TRACKING USER ACTIVITIES

(71) Applicant: Synchrony Bank, Draper, UT (US)

(72) Inventors: Balamourougan Raganathan, Alpharetta, GA (US); Cedric Perkins, Stamford, CT (US); Daniel Murphy, Stamford, CT (US); Joseph Nelly, Stamford, CT (US); Jake Miller, Stamford, CT (US)

(21) Appl. No.: 16/296,992

(22) Filed: Mar. 8, 2019

(51) Int. Cl. G06Q 30/02; G06Q 40/02

(52) U.S. Cl. CPC G06Q 30/0201; G06Q 30/0226; G06Q 40/025

(57) ABSTRACT

A child application executed by a computing device receives user information from and provides user data to an end user via a user interface implemented by the computing device. A host application executed by the computing device is unable to obtain the user information and the user data from the user interface. The host application obtains the user information and the user data from the child application only via a connection line connecting the child and host applications. The host application receives an identification that uniquely identifies the end user to a host application server and provides the identification to the child application. The child application sends the identification to a child application server. The child application server creates a customer relationship management (“CRM”) profile for the end user, associates the identification with the CRM profile, and associates activities of the end user with the CRM profile.

### BACKGROUND OF THE INVENTION

### Field of the Invention

The present invention is directed generally to methods of tracking user activities and using that information to inform interactions with the user.

### BRIEF DESCRIPTION OF THE SEVERAL VIEWS OF THE DRAWING(S)

FIG. 1A is a reproduction of FIG. 1 of U.S. patent application Ser. No. 15/297,589 that illustrates a system.

FIG. 1B is a block diagram illustrating a host profile stored by a host application server of the system of FIG. 1A.

FIG. 1C is a block diagram illustrating software components stored by a child application server of the system of FIG. 1A.

FIG. 1D is a block diagram illustrating software components of an acquisition system implemented by the child application server illustrated in FIG. 1C.

FIG. 2 is a flow diagram of an enrollment method performed by the system of FIG. 1A.

FIG. 3 is a flow diagram of a method performed by the system of FIG. 1A.

FIG. 4 is a flow diagram of an apply method performed by the child application server illustrated in FIG. 1C.

FIG. 5 is a flow diagram of an acquisition method performed by the child application server illustrated in FIG. 1C.

FIG. 6 is a diagram of a hardware environment and an operating environment in which the computing devices of the system of FIG. 1A may be implemented.

Like reference numerals have been used in the figures to identify like components.

### DETAILED DESCRIPTION OF THE INVENTION

As credit product offerings become more diverse and reach a wider range of customer's based on eligibility and financial health, a need has developed for a frictionless way to identify an appropriate credit product for a particular customer as well as a frictionless way to enroll the customer into the various loyalty, benefit, and data tracking programs associated with the credit product.

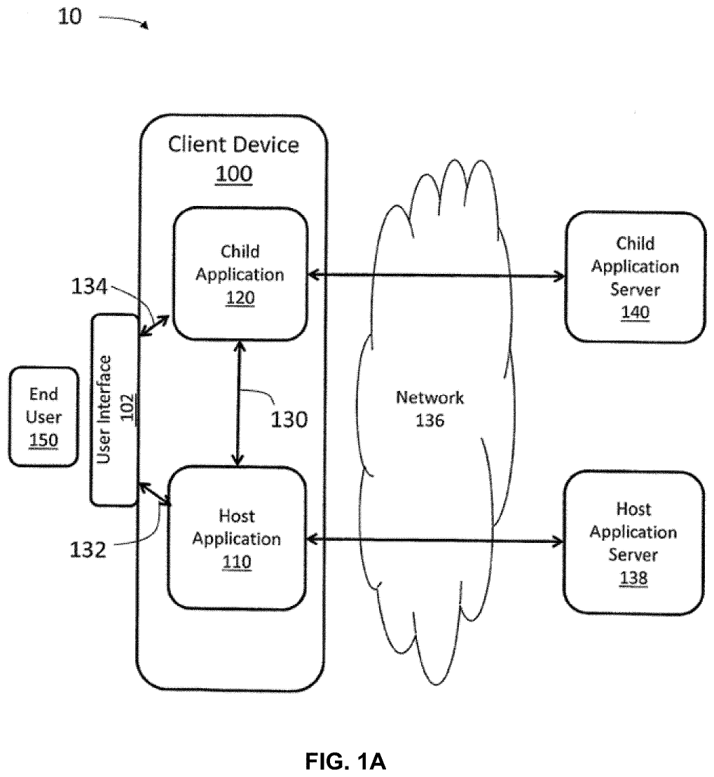

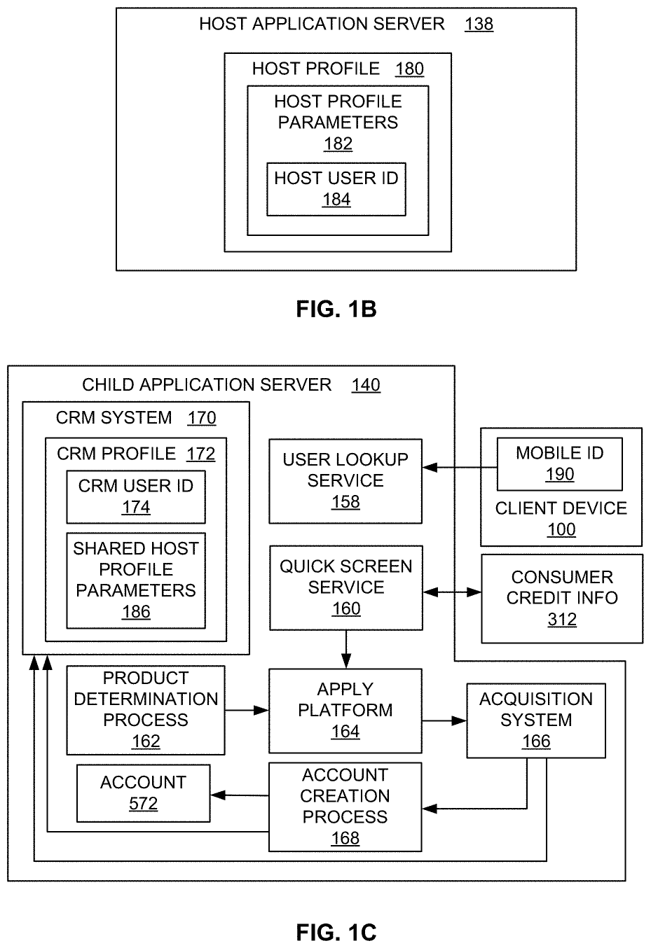

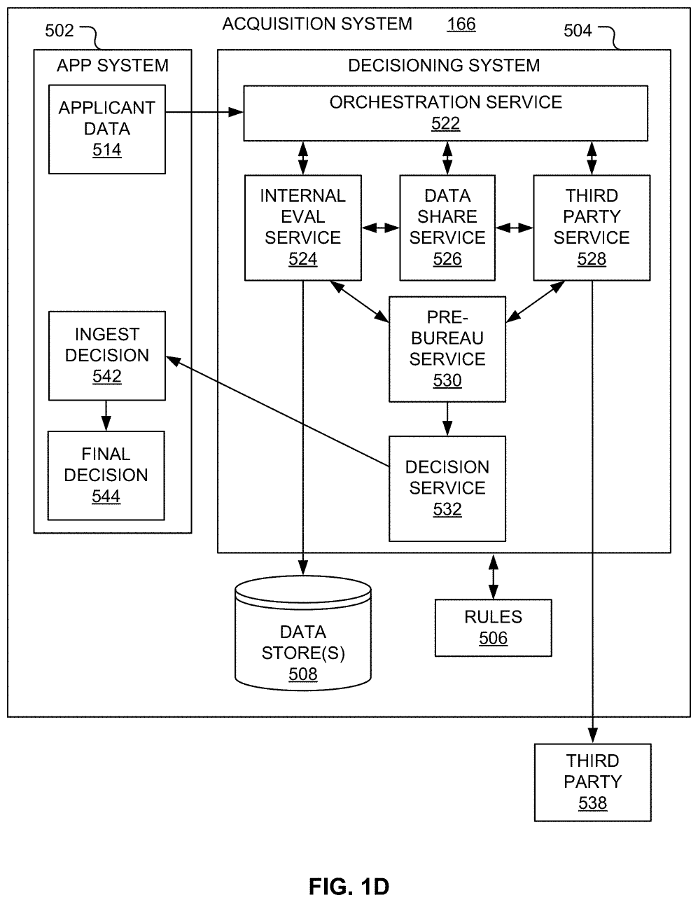

U.S. patent application Ser. No. 15/297,589, filed on Oct. 19, 2016, and titled “System and Method for Integrating Data from a Remote Server with a Client Application,” is incorporated herein by reference in its entirety. FIG. 1A of the present application is a reproduction of FIG. 1 of U.S. patent application Ser. No. 15/297,589. Referring to FIG. 1A, U.S. patent application Ser. No. 15/297,589 discloses a system 10 for extending functionality of a host application 110 using data that is inaccessible to the host application 110. The system 10 may include a client device 100, a host application server 138, and a child application server 140. The client device 100 may be any computing device configured to interface with the end user 150 and/or the servers 138 and 140. Examples of the client device 100 may include a smart phone, a tablet, and a personal computer, among others. The client device 100 includes a user interface 102 configured to receive inputs from and display data to an end user 150. Examples of the user interface 102 include touch screens, and monitors with peripheral components such as a keyboard and mouse, among other things.

The client device 100 is configured to execute both the host application 110 and a child application 120. The host application 110 connects to the host application server 138 and the child application 120 connects to the child application server 140 via a network 136. The network 136 may be implemented using any suitable communication channel, including wired or wireless communication channels and links. The network 136 may be implemented at least in part by an intranet and/or an Internet.

The host application 110 is configured to generate graphical user interfaces for display by the user interface 102 to the end user 150. The host application 110 may receive user inputs from the end user 150 via the user interface 102. Alternatively, the host application 110 may request data from the host application server 138 and/or the child application 120 for display via the user interface 102.

The host application 110 and the child application 120 exchange data with the user interface 102 via connection lines 132 and 134, respectively. Using the connection lines 132 and 134, the host application 110 and the child application 120 can control the user interface 102 by transmitting user interface data to the user interface 102. Upon receipt, the user interface 102 generates a graphical user interface for display to the end user 150. The user interface 102 may receive user inputs from the end user 150 and transmit data representative of the user inputs to the host application 110 and the child application 120 via the connection lines 132 and 134, respectively.

The host application 110 and the child application 120 exchange data with one another via connection line 130. Using the connection line 130, the host application 110 can request that the child application 120 control of the user interface 102. As discussed herein, the child application 120 controls the user interface 102, the child application 120 can interact with the end user 150 so that the end user 150 can provide personal information without fear of access by the host application 110. Using the connection line 130, the host application 110 can request data associated with that personal information from the child application 120. The child application 120 can provide the requested data to the host application 110 over the connection line 130. Thus, the connection line 130 may be configured to provide bidirectional communication between the host application 110 and the child application 120 and may reside entirely on the client device 100.

The host application server 138 may be any computing device configured to manage access to a centralized resource or service in a network 136. In some embodiments, the host application server 138 may provide data resources to facilitate the host application 110 with providing graphical user interfaces to the end user 150. For example, the host application server 138 may host retailer data used for shopping or commerce, among others.

The child application server 140 may be any computing device configured to manage access to a centralized resource or service in the network 136. The child application server 140 may provide data resources to facilitate the child application 120 with providing graphical user interfaces to the end user 150. The child application server 140 may host, for the end user 150, personal information including financial account information, transaction history, credit or fund availability on a bank account, payment processing information, and digital receipt information from a financial institution.

As explained in U.S. patent application Ser. No. 15/297,589, personal information of the end user 150 may be protected from being compromised by the host application 110 (e.g., a retailer application) by integrating features from the child application 120 (e.g., a financial institution application) into the host application 110 while simultaneously preventing exposure of that personal information to the host application 110. The host application server 138 may be operated by a retailer and the child application server 140 may be operated by a financial institution (e.g., a credit card company, a bank, and the like). Thus, the system 10 may be used to offer to the end user 150 credit products (e.g., private label credit cards) and/or other services, such as installment loans and dual-cards.

The child application 120 may be invoked by the host application 110 and interact with the end user 150 via the user interface 102. For example, in some embodiments, the child application 120 may be a financial services application that provides financial services that extend functionality of the host application 110. By way of non-limiting examples, the child application 120 may be programmed to execute additional financial services of the host application 110 specific to the end user 150, such as accessing and displaying financial account information, transaction history, credit or fund availability on a bank account, payment processing information, and digital receipt information, among others.

Referring to FIG. 1C, the child application server 140 may implement a user lookup service 158, a quick screen service 160, a product determination process 162, an apply platform 164, an acquisition system 166, an account creation process 168, and a customer relationship management (“CRM”) system 170.

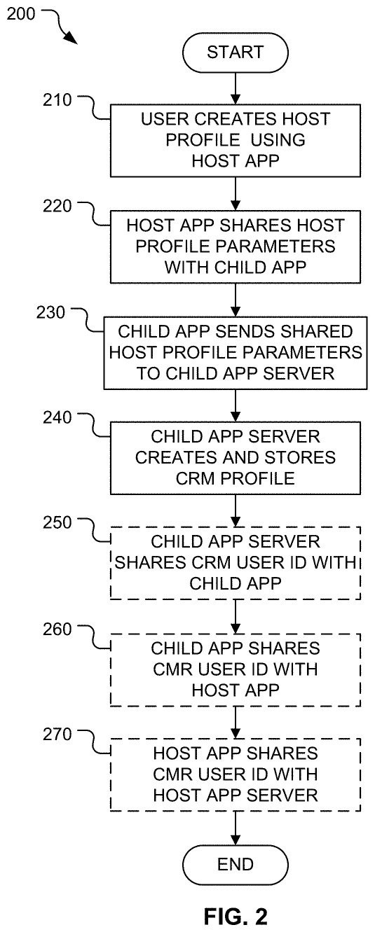

FIG. 2 is a flow diagram of an enrollment method 200 that may be used to enroll the end user 150 (see FIG. 1A) with the CRM system 170 (see FIG. 1C). The enrollment method 200 may be performed when the end user 150 is not logged into the child application server 140 (see FIGS. 1A and 1C) or before the end user 150 has established an account with the child application server 140.

In first block 210, the end user 150 creates a host profile 180 (see FIG. 1B) using the user interface 102 (see FIG. 1A) and the host application 110 (see FIG. 1A). Referring to FIG. 1A, the host application 110 communicates with the host application server 138, which creates the host profile 180 (see FIG. 1B) for the end user 150. Referring to FIG. 1B, the host profile 180 includes host profile parameters 182. The host profile parameters 182 include a host user identification 184 that uniquely identifies the end user 150 with respect to the host application server 138. Referring to FIG. 1A, the host application server 138 communicates at least a portion of the host profile parameters 182 (see FIG. 1B) with the host application 110.

Next, in block 220 (see FIG. 2), the host application 110 shares at least some of the host profile parameters 182 (illustrated as shared host profile parameters 186 in FIG. 1C) with the child application 120 via the connection line 130. For example, the host application 110 may provide one or more of the following host profile parameters 182 (see FIG. 1B) to the child application 120:
1. First Name of the end user 150;
2. Last Name of the end user 150;
3. Email Address of the end user 150;
4. Physical Address of the end user 150;
5. Mobile Telephone Number of the end user 150;
6. Consent(s) (e.g., Payfone Consent) Granted by the end user 150; and
7. The host user identification 184.

In block 230 (see FIG. 2), the child application 120 sends the shared host profile parameters 186 (see FIG. 1C) to the child application server 140.

Referring to FIG. 1C, in block 240 (see FIG. 2), the CRM system 170 implemented by the child application server 140 creates a CRM profile 172 that includes the shared host profile parameters 186 and a CRM user identification 174 that uniquely identifies the end user 150 with respect to the CRM system 170.

Next, referring to FIG. 1A, the child application server 140 may share the CRM user identification 174 (see FIG. 1C) with the child application 120 in optional block 250 (see FIG. 2).

In optional block 260 (see FIG. 2), the child application 120 may share the CRM user identification 174 (see FIG. 1C) with the host application 110 via the connection line 130.

In optional block 270, the host application 110 may share the CRM user identification 174 (see FIG. 1C) with the host application server 138, which may store the CRM user identification 174 in the host profile 180 (see FIG. 1B) or associate the CRM user identification 174 with the host profile 180.

Then, the enrollment method 200 terminates.

Referring to FIG. 1C, from this point forward, the CRM system 170 may use the CRM profile 172 to track activities of the end user 150. Thus, the CRM profile 172 may be used to track user data for the purposes of implementing CRM functions, such as loyalty programs, authenticating the end user 150, identifying the end user 150, implementing rewards, and performing general information management. The CRM profile 172 may be used to track any number of different users who have not created separate accounts with the child application server 140. The child application server 140 can provide any information associated with the CRM profile 172 to the host application 110, which may share the information with the host application server 138.

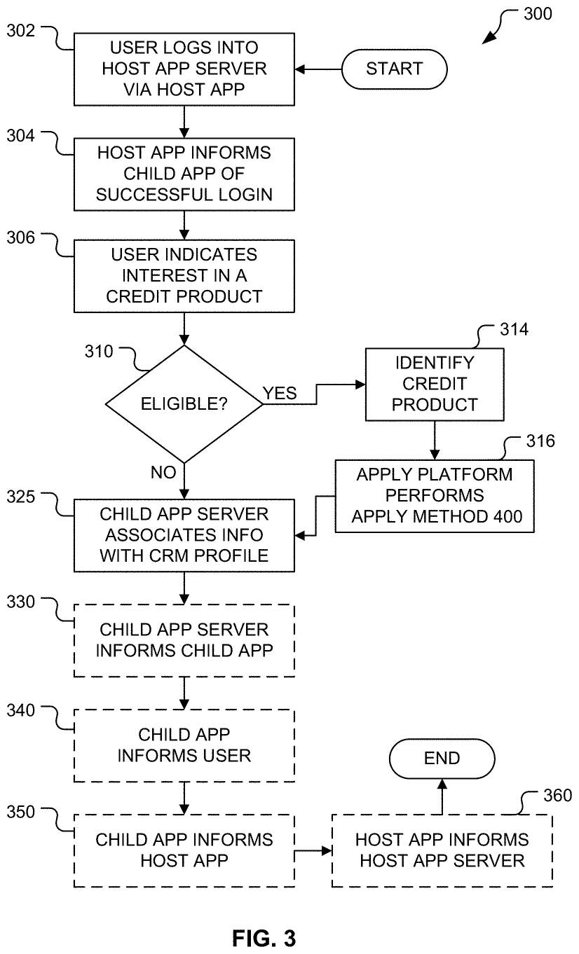

FIG. 3 is a flow diagram of a method 300 of applying for a credit product using the system 10 (see FIG. 1A). The method 300 supplies information to the CRM system 170 (see FIG. 1C) that the CRM system 170 may use to implement CRM functions.

In first block 302, referring to FIG. 1A, the end user 150 logs onto the host application server 138 using the user interface 102, the host profile 180 (see FIG. 1B), and the host application 110.

Next, in block 304 (see FIG. 3), the host application 110 informs the child application 120 of the successful login and shares the host user identification 184 (see FIG. 1B) and/or the CRM user identification 174 (see FIG. 1C) with the child application 120. Thus, at this point, the end user 150 has been both identified and authenticated by the host application server 138.

In block 306 (see FIG. 3), the end user 150 indicates an interest in a credit product. For example, as described in U.S. patent application Ser. No. 15/297,589, the user may navigate through the host application 110 to the child application 120, which may present the end user 150 with a user interface (illustrated in FIG. 2M of the U.S. patent application Ser. No. 15/297,589) that includes an offer for credit (e.g., a Rock Red Store Card). The end user 150 may indicate an interest in the credit product by selecting (e.g., clicking on) the offer. Alternatively, the interest may be indicated to the host application 110, which may communicate this interest to the child application 120. The child application 120 communicates this interest to the child application server 140.

In block 306 (see FIG. 3), the child application server 140 may also identify and authenticate the end user 150. For example, referring to FIG. 1C, the client device 100 may store a mobile identification 190. The user lookup service 158 has access to records associating the mobile identification 190 with the end user 150 (see FIG. 1A). Thus, the client device 100 may transfer the mobile identification 190 to the child application server 140 and the user lookup service 158 may look up the mobile identification 190 to thereby authenticate and identify the end user 150 (see FIG. 1A).

In decision block 310 (see FIG. 3), the quick screen service 160 determines whether the end user 150 (see FIG. 1A) is potentially eligible for a credit product. The quick screen service 160 may query one or more sources of consumer credit information 312 (e.g., a credit bureau) for credit information (e.g., a credit score) associated with the end user 150 (see FIG. 1A). The quick screen service 160 may perform a soft-bureau inquiry (or hit) and may utilizes the same credit bureau data used in conventional underwriting. Optionally, the quick screen service 160 may forward at least some of the credit information to the CRM system 170, which may store the credit information in or associate the credit information with the CRM profile 172.

The decision in decision block 310 (see FIG. 3) is “YES,” when the quick screen service 160 (see FIG. 1C) determines that the end user 150 is potentially eligible for a credit product. Otherwise, the decision in decision block 310 (see FIG. 3) is “NO.” Thus, in decision block 310 (see FIG. 3), the quick screen service 160 may pre-screen the end user 150 (see FIG. 1A) for eligibility with respect to the credit product(s) offered by the financial institution operating the child application server 140. In decision block 310 (see FIG. 3), the quick screen service 160 may determine the end user 150 (see FIG. 1A) is potentially eligible for a credit product if the credit score is greater than a first threshold value. Otherwise, the quick screen service 160 may determine the end user 150 (see FIG. 1A) is not eligible for any credit product offered by the financial institution.

When the decision in decision block 310 (see FIG. 3) is “YES,” in block 314 (see FIG. 3), the quick screen service 160 forwards at least some of the credit information (referred to as “eligibility information” below) to the apply platform 164 and forwards at least some of the credit information to the product determination process 162. In block 314, the product determination process 162 uses the credit information to identify a particular one of the credit product(s) for which the end user 150 potentially qualifies. The product determination process 162 may also use other information stored by or associated with the CRM profile 172 and/or the host profile 180 to determine whether the end user 150 is potentially eligible for the particular credit product.

By way of non-limiting examples, in block 314 (see FIG. 3), the product determination process 162 may determine whether the end user 150 (see FIG. 1A) is eligible for an entry level credit product (e.g., installment loans and secured credit cards), transactional financing, or a private label credit card. In this example, it is more difficult to qualify for transactional financing than for the entry level credit product and it is more difficult to qualify for the private label credit card than for transactional financing. Transactional financing refers to a loan made to complete a particular transaction (e.g., to purchase an expensive item). By way of a non-limiting example, the particular credit product may be the entry level credit product if the credit score is less than a second threshold value. The second threshold value is greater than the first threshold value. If the product determination process 162 determines the credit score is greater than a third threshold value, the particular credit product may be a private label credit card. The third threshold value is greater than the second threshold value. The particular credit product may be transactional financing if the credit score is greater than the second threshold value and less than the third threshold value.

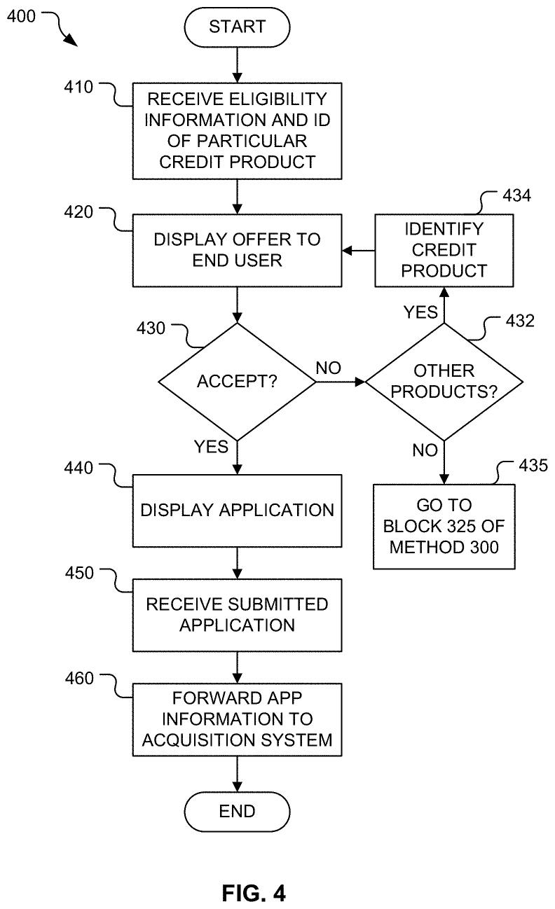

Then, the product determination process 162 forwards the identification of the particular credit product to the apply platform 164. Next, in block 316, the apply platform 164 performs an apply method 400 (see FIG. 4). Then, the child application server 140 advances to block 325 (see FIG. 3).

Referring to FIG. 3, when the decision in decision block 310 is “NO,” in block 325, the child application server 140 (see FIG. 1A) associates information with the CRM profile 172 (see FIG. 1C). In this example, the information is related to the determination made in decision block 310. However, as will be described below, this information may include other types of data. Information associated with the CRM profile 172 (see FIG. 1C) may be used the next time the child application server 140 (see FIG. 1A) performs decision block 310. Alternatively, the information may be used by the CRM system 170 (see FIG. 1C) when performing a CRM function.

Next, in optional block 330, the child application server 140 (see FIGS. 1A and 1C) may share a portion of the information (e.g., the determination made in decision block 310) with the child application 120 (see FIG. 1A).

In optional block 340, the child application 120 (see FIG. 1A) may share the portion of the information (e.g., the determination made in decision block 310) with the end user 150 (see FIG. 1A).

In optional block 350, the child application 120 (see FIG. 1A) may share the portion of the information (e.g., the determination made in decision block 310) with the host application 110 (see FIG. 1A). Optionally, in block 360, the host application 110 (see FIG. 1A) may share portion of the information (e.g., the determination made in decision block 310) with the host application server 138 (see FIG. 1A).

Then, the method 300 terminates.

FIG. 4 is a flow diagram of the apply method 400 performed by the apply platform 164 (see FIG. 1C). The apply method 400 supplies information to the CRM system 170 (see FIG. 1C) that the CRM system 170 may use to implement CRM functions. In first block 410, the apply platform 164 (see FIG. 1C) receives the eligibility information from the quick screen service 160 (see FIG. 1C) and the identification of the particular credit product from the product determination process 162 (see FIG. 1C).

In block 420, the apply platform 164 (see FIG. 1C) displays an offer to the end user 150 (see FIG. 1A) for the particular credit product and receives a response from the end user 150. For example, the end user 150 may be presented with a user interface similar to a user interface illustrated in FIG. 2M of the U.S. patent application Ser. No. 15/297,589 that includes an offer for a private label credit card (e.g., a Rock Red Store Card). The end user 150 (see FIG. 1A) may respond by selecting (e.g., clicking on) a user input (e.g., an “Apply with Synchrony Bank” selectable icon 252 illustrated in FIG. 2M of the U.S. patent application Ser. No. 15/297,589) associated with the offer.

The decision in decision block 430 is “YES,” when the end user 150 (see FIG. 1A) has accepted the offer. Otherwise, the decision in decision block 430 is “NO.”

When the decision in decision block 430 is “NO,” in decision block 432, the apply platform 164 (see FIG. 1C) determines whether the end user 150 potentially qualifies for another one of the credit product(s). For example, if in block 314 (see FIG. 3) the product determination process 162 identified a private label credit card, the apply platform 164 (see FIG. 1C) may determine that the end user 150 also potentially qualifies for transactional financing and an entry level credit product in decision block 432. Similarly, if in block 314 (see FIG. 3) the product determination process 162 identified transactional financing, the apply platform 164 (see FIG. 1C) may determine that the end user 150 also qualifies for an entry level credit product in decision block 432. The decision in decision block 432 is “YES” when the apply platform 164 (see FIG. 1C) determines the end user 150 potentially qualifies for another one of the credit product(s). Otherwise, the decision in decision block 432 is “NO.”

When the decision in decision block 432 is “YES,” in block 434, the apply platform 164 (see FIG. 1C) identifies another particular one of the credit product(s) for which the end user 150 potentially qualifies. Then, the apply platform 164 (see FIG. 1C) returns to block 420 whereat the apply platform 164 displays an offer to the end user 150 (see FIG. 1A) for the particular credit product identified in block 434 and receives a response from the end user 150.

When the decision in decision block 432 is “NO,” in block 435, the child application server 140 (see FIG. 1A) goes to block 325 of the method 300 illustrated in FIG. 3. In block 325, the information associated with the CRM profile 172 (see FIG. 1C) may include the decision by the end user 150 (see FIG. 1A) to decline the offer.

On the other hand referring to FIG. 4, when the decision in decision block 430 is “YES,” in block 440, the apply platform 164 (see FIG. 1C) displays a credit application to the end user 150 (see FIG. 1A). In block 440, the apply platform 164 may instruct the child application 120 (see FIG. 1A) to display the credit application on the user interface 102 (see FIG. 1A). In response to this instruction, the child application 120 (see FIG. 1A) displays the credit application on the user interface 102 (see FIG. 1A). The credit application may include pre-filled information (e.g., information shared between host and child applications 110 and 120 illustrated in FIG. 1A) and user options to change and/or enter additional data. FIG. 2O of the U.S. patent application Ser. No. 15/297,589 is an example of such a credit application. By way of non-limiting examples, the end user 150 (see FIG. 1A) may enter the DOB of the end user 150, the annual income of the end user 150, and the like. In block 440, if the end user 150 does not have an account with the child application server 140 (see FIG. 1A), the end user 150 may create an account and supply a username and a password. FIG. 2P of the U.S. patent application Ser. No. 15/297,589 is an example of a user interface for entering the username and password. If the end user 150 (see FIG. 1A) wishes to proceed, the end user 150 submits the credit application.

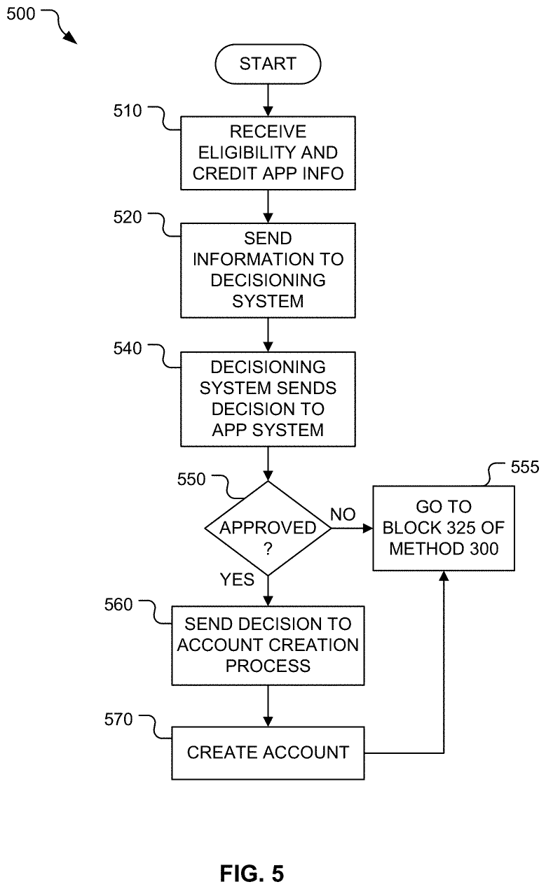

Then, in block 450, the apply platform 164 (see FIG. 1C) receives the submitted credit application from the end user 150 (see FIG. 1A). The end user 150 may submit the credit application via the user interface 102 (see FIG. 1A). The credit application may be submitted to the child application 120 (see FIG. 1A), which may forward the submission to the apply platform 164 (see FIG. 1C). The child application 120 may not share the submission with the host application 110 (see FIG. 1A). The submission includes at least a portion of the credit application. Next, in block 460, the apply platform 164 (see FIG. 1C) submits the eligibility information and the credit application information, in tandem, to the acquisition system 166 (see FIG. 1C). The acquisition system 166 is configured to perform an acquisition method 500 (see FIG. 5). Then, the apply method 400 terminates.

FIG. 5 is a flow diagram of the acquisition method 500 performed by the acquisition system 166 (see FIG. 1C). The acquisition method 500 supplies information to the CRM system 170 (see FIG. 1C) that the CRM system 170 may use to implement CRM functions. Referring to FIG. 1D, the acquisition system 166 may include an application system 502, a decisioning system 504, rules 506, and one or more data stores 508.

In first block 510 (see FIG. 5), the acquisition system 166 receives the eligibility information and the credit application information from the apply platform 164 (see FIG. 1C). The eligibility information and the credit application information are illustrated as applicant data 514 in FIG. 1D. The applicant data 514 is accessible by the application system 502.

In next block 520, the application system 502 sends the applicant data 514 (or pointers thereto) to an orchestration service 522 operating within the decisioning system 504. The orchestration service 522 controls the decision making process. For example, the orchestration service 522 may control data flows between different components of the decisioning system 504. Such components may include an internal evaluation service 524, a data share service 526, a third party service 528, a pre-bureau service 530, and a decision service 532. The internal evaluation service 524 may interact with the data store(s) 508 that store(s) non-relational applicant data. The internal evaluation service 524 may use the non-relational applicant data to generate analytics that are used by the decision service 532 to make a credit decision. The data share service 526 may send a client data share request to one or more third parties that might provide underwriting. The decision service 532 may consider whether underwriting is available when making the credit decision. The pre-bureau service 530 formats or conditions consumer data so that the consumer data can be run against bureau data. The third party service 528 may interact with one or more third party sources 538 (e.g., Experian Fraud Detection and Prevention (“FDP”), IDA, Socure, LexID, Clarity, Factor Trust, and the like). This interaction may be used to evaluate a fraud risk associated with granting the credit requested. The decision service 532 may consider the fraud risk when making the credit decision.

In block 540, the decisioning system 504 makes a credit decision and sends the credit decision to the application system 502. While making the decision, the decisioning system 504 may interact with the rules 506. The rules 506 may include separate rules used to implement the orchestration service 522 and the pre-bureau service 530. Additionally, the rules 506 implement bureau logic, model logic, credit strategy, and fraud strategy.

In the embodiment illustrated in FIG. 1D, the application system 502 includes a process 542 configured to ingest the credit decision and create a final credit decision 544. If the final credit decision 544 is to approve the end user 150 for the particular credit product, the decision in decision block 550 (see FIG. 5) is “YES.” Otherwise, the decision in decision block 550 is “NO.”

Referring to FIG. 5, when the decision in decision block 550 is “NO,” in block 555, the child application server 140 (see FIGS. 1A and 1C) goes to block 325 of the method 300 illustrated in FIG. 3. In block 325, the information associated with the CRM profile 172 (see FIG. 1C) may include the information related the decision made in block 540 (see FIG. 5).

Referring to FIG. 5, when the decision in decision block 550 is “YES,” in block 560, the application system 502 (see FIG. 1D) sends the final credit decision 544 (see FIG. 1D) to the account creation process 168 (see FIG. 1C) executing on the child application server 140 (see FIGS. 1A and 1C). Then, in block 570, the account creation process 168 (see FIG. 1C) creates an account 572 (see FIG. 1C) for the end user 150 (see FIG. 1A). Lastly, in block 555, the child application server 140 goes to block 325 of the method 300 illustrated in FIG. 3. In block 325, the information associated with the CRM profile 172 (see FIG. 1C) may include the information related to the account 572 and/or the decision made in block 540.

Thus, if the end user 150 (see FIG. 1A) accepted the offer displayed in block 420 (see FIG. 4), the end user 150 proceeds through a pre-filled application and is decisioned by the acquisition system 166 (see FIGS. 1C and 1D). Upon approval, the account 572 (see FIG. 1C) is created and the end user 150 (see FIG. 1A) gains instant access to a credit line that is part of the particular credit product. Throughout the methods 200-500 illustrated in FIGS. 2-5, respectively, the CRM system 170 (see FIG. 1C) and/or several databases are updated with information related to the end user 150, including information related to the account 572 (see FIG. 1C) and identifiers that are mapped to the end user 150.

### Computing Device

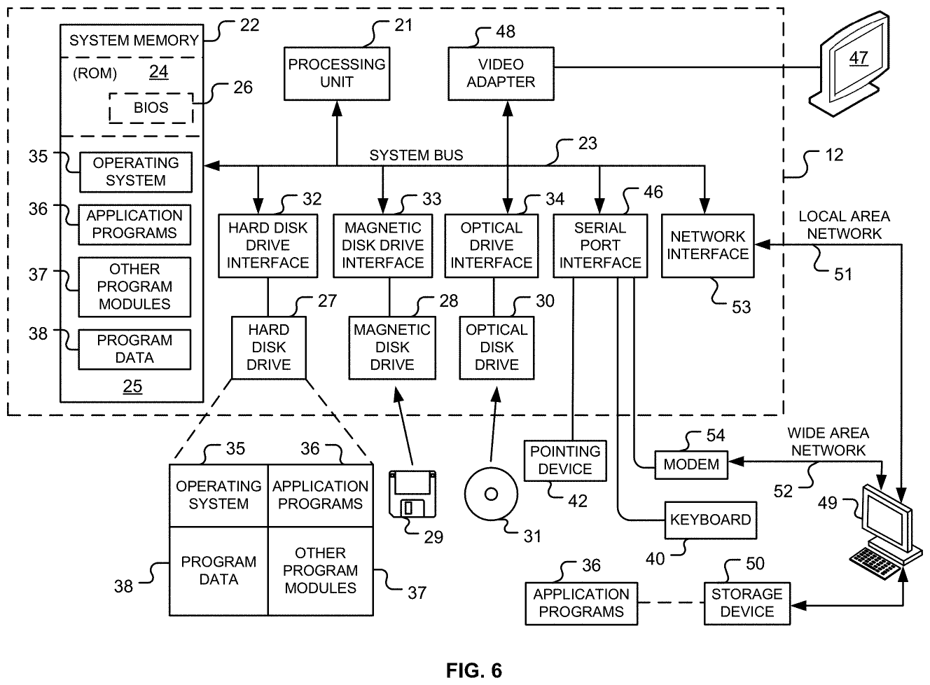

FIG. 6 is a diagram of hardware and an operating environment in conjunction with which implementations of the one or more computing devices of the system 10 (e.g., the client device 100, the host application server 138, and the child application server 140) may be practiced. The description of FIG. 6 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those of ordinary skill in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments (e.g., cloud computing platforms) where tasks are performed by remote processing devices that are linked through a communications network. In a distributed computing environment, program modules may be located in both local and remote memory storage devices.

The exemplary hardware and operating environment of FIG. 6 includes a general-purpose computing device in the form of the computing device 12. Each of the computing devices of FIG. 1A (including the client device 100, the host application server 138, and the child application server 140) may be substantially identical to the computing device 12. By way of non-limiting examples, the computing device 12 may be implemented as a laptop computer, a tablet computer, a web enabled television, a personal digital assistant, a game console, a smartphone, a mobile computing device, a cellular telephone, a desktop personal computer, and the like.

The computing device 12 includes a system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those of ordinary skill in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including the operating system 35, one or more application programs 36, other program modules 37, and program data 38. A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types of physical feedback (e.g., a force feed back game controller).

The input devices described above are operable to receive user input and selections. Together the input and display devices may be described as providing a user interface.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 6 include a local-area network (LAN) 51 and a wide-area network (WAN) 52. Such networking environments are commonplace in offices, enterprise-wide computer networks, intranets and the Internet. The network 136 (see FIG. 1A) may be implemented using one or more of the LAN 51 or the WAN 52 (e.g., the Internet).

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores computer executable instructions that when executed by one or more processors cause the one or more processors to perform all or portions of one or more of the methods (including the methods 200-500 illustrated in FIGS. 2-5, respectively) described above. Such instructions may be stored on one or more non-transitory computer-readable media.

In some embodiments, the system memory 22 stores computer executable instructions that when executed by one or more processors cause the one or more processors to generate the graphical user interfaces described above as being displayed by the user interface 102 (see FIG. 1A). Such instructions may be stored on one or more non-transitory computer-readable media.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood with the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B, and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context.

Accordingly, the invention is not limited except as by the appended claims.

1-20. (canceled)

21. A computer-implemented method, comprising:
receiving an indication of a successful host application server login using host profile parameters via a host application operating on an electronic device, wherein the host profile parameters are associated with a host profile for a user, and wherein the host application is associated with a host server;
invoking a child application, wherein the child application is associated with a child server that includes a child profile for the user, wherein the child server is distinct from the host server, wherein the child profile is associated with the host profile, and wherein associating includes using the host profile parameters;
communicating the host profile parameters;
receiving an indication of an interest in a credit product;
segmenting, by the child application, personal information, wherein segmenting prevents the personal information from being exposed to the host application;
facilitating communications between the child application and the host application, wherein the communications are associated with the credit product; and
dynamically sending data including the personal information and portions of the communications, wherein when the data is received at a child application server, and wherein the child application server can include the data in the child profile.

22. The method of claim 21 further comprising generating an integrated user interface display based on the data associated with the host application and segmented user data, wherein segmentation prevents the segmented user data associated with the child application from being exposed to the host application during generation of an integrated display.

23. The method of claim 21 further comprising:
receiving, by the child application in response to the communicating of the host profile parameters, user data.

24. The method of claim 23, wherein the user data comprises a customer relationship management (“CRM”) profile created by a child application server and associated with the host profile parameters.

25. The method of claim 24, wherein the CRM profile is further associated with activity data stored on the child application server.

26. The method of claim 25, further comprising:
receiving, by the child application, input data associated with an indication that an end user would like to apply for credit;
communication, by the child application, request data associated with the input data to the child application server;
receiving, by the child application, response data to the request data, the response data indicating a determination by a quick screen service executing on the child application server, a credit determination for the end user.

27. The method of claim 26 further comprising associating declined information with the CRM profile when the credit determination indicates the end user is not eligible for the credit.

28. The method of claim 27 wherein the declined information is based on activities associated with the CRM profile, the activities including two or more of loyalty program activity, end user authentication activity, reward program activity, and information management activity;
wherein the CRM profile is created for the end user before the end user has logged into the child application server.

29. The method of claim 26 further comprising identifying a particular credit product of a plurality of credit products for which the end user qualifies when the credit determination indicates that the end user is eligible for the credit;
transmitting, by the child application, a submission from the end user indicating the end user would like to apply for the particular credit product; and
receiving, by the child application, a response to the submission indicating a final credit determination associated with the particular credit product.

30. The method of claim 21 further comprising:
receiving, at the child application, an instruction to display a credit application to on a user interface;
displaying, by the child application, the credit application on the user interface, the credit application associated with an application for a particular credit product;
receiving, by the child application from the user interface, submission data including at least a portion of the credit application; and
forwarding, by the child application, the submission data to a child application server without sharing the submission data with the host application or a host application server.

31. A system comprising:
a memory configured to store an indication of a successful host application server login using host profile parameters via a host application operating on an electronic device, wherein the host profile parameters are associated with a host profile for a user, and wherein the host application is associated with a host server; and
one or more processors coupled to the memory and configured to segment data between a host application and a child application executed using the one or more processors with operations comprising:
invoking a child application, wherein the child application is associated with a child server that includes a child profile for the user, wherein the child server is distinct from the host server, wherein the child profile is associated with the host profile, and wherein associating includes using the host profile parameters;
communicating the host profile parameters;
receiving an indication of an interest in a credit product;
segmenting, by the child application, personal information, wherein segmenting prevents the personal information from being exposed to the host application;
facilitating communications between the child application and the host application, wherein the communications are associated with the credit product; and
dynamically sending data including the personal information and portions of the communications, wherein when the data is received at a child application server, and wherein the child application server can include the data in the child profile.

32. The system of claim 31, wherein the one or more processors are further configured for operations comprising generating an integrated user interface display based on the data associated with the host application and segmented user data, wherein segmentation prevents the segmented user data associated with the child application from being exposed to the host application during generation of an integrated display.

33. The system of claim 31, wherein the one or more processors are further configured for operations comprising receiving, by the child application in response to the communicating of the host profile parameters, user data.

34. The system of claim 33, wherein the user data comprises a customer relationship management (“CRM”) profile created by a child application server and associated with the host profile parameters.

35. The system of claim 34, wherein the CRM profile is further associated with activity data stored on the child application server.

36. The system of claim 35, wherein the one or more processors are further configured for operations comprising:
receiving, by the child application, input data associated with an indication that an end user would like to apply for credit;
communication, by the child application, request data associated with the input data to the child application server;
receiving, by the child application, response data to the request data, the response data indicating a determination by a quick screen service executing on the child application server, a credit determination for the end user.

37. The system of claim 36, wherein the one or more processors are further configured for operations comprising associating declined information with the CRM profile when the credit determination indicates the end user is not eligible for the credit.

38. A non-transitory computer readable medium comprising instructions that, when executed by one or more processors of a device, cause the device to perform operations comprising:
receiving an indication of a successful host application server login using host profile parameters via a host application operating on an electronic device, wherein the host profile parameters are associated with a host profile for a user, and wherein the host application is associated with a host server;
invoking a child application, wherein the child application is associated with a child server that includes a child profile for the user, wherein the child server is distinct from the host server, wherein the child profile is associated with the host profile, and wherein associating includes using the host profile parameters;
communicating the host profile parameters;
receiving an indication of an interest in a credit product;
segmenting, by the child application, personal information, wherein segmenting prevents the personal information from being exposed to the host application;
facilitating communications between the child application and the host application, wherein the communications are associated with the credit product; and
dynamically sending data including the personal information and portions of the communications, wherein when the data is received at a child application server, and wherein the child application server can include the data in the child profile.

39. The non-transitory computer readable medium of claim 38, wherein the instructions further cause the device to perform operations comprising:
receiving, by the child application in response to the communicating of the host profile parameters, user data;
receiving, by the child application, input data associated with an indication that an end user would like to apply for credit;
communication, by the child application, request data associated with the input data to the child application server; and
receiving, by the child application, response data to the request data, the response data indicating a determination by a quick screen service executing on the child application server, a credit determination for the end user;
wherein the user data comprises a customer relationship management (“CRM”) profile created by a child application server and associated with the host profile parameters.

40. The non-transitory computer readable medium of claim 38, wherein the instructions further cause the device to perform operations comprising:
receiving, at the child application, an instruction to display a credit application to on a user interface;
displaying, by the child application, the credit application on the user interface, the credit application associated with an application for a particular credit product;
receiving, by the child application from the user interface, submission data including at least a portion of the credit application; and
forwarding, by the child application, the submission data to a child application server without sharing the submission data with the host application or a host application server.
